(19) United States
(12) Patent Application Publication
(10) Pub. No.: US 2026/0066251 A1
(43) Pub. Date: Mar. 5, 2026

(54) MASS SPECTROMETER RESOLUTION ENHANCEMENT METHOD AND SYSTEM BASED ON DATA ANALYSIS

(71) Applicant: Yantai Zhigong Biomedical Technology Co., Ltd, Yantai (CN)

(72) Inventor: Tuanjie CHE, Yantai (CN)

(73) Assignee: Yantai Zhigong Biomedical Technology Co., Ltd, Yantai (CN)

(21) Appl. No.: 19/382,309

(22) Filed: Nov. 7, 2025

Related U.S. Application Data
(63) Continuation of application No. PCT/CN2025/110774, filed on Jul. 26, 2025.

(30) Foreign Application Priority Data
Sep. 3, 2024 (CN) 202411225118.4

(51) Int. Cl. H01J 49/00; G01N 30/72

(52) U.S. Cl. CPC H01J 49/0036; G01N 30/7206

(57) ABSTRACT

A method and a system for mass spectrometer resolution enhancement based on data analysis are provided. The method includes: training a resolution factor model; determining basic information of a to-be-detected compound according to an original mass spectrum and an original fragment spectrum, determining a target signal-to-noise ratio of the original mass spectrum according to a mass spectrum of the standard compound, and performing denoising processing on the original mass spectrum through a noise reduction means; determining a baseline reference region according to the denoised original mass spectrum and the mass spectrum of the standard compound; identifying characteristics of peaks in the mass spectrum, separating overlapped peaks through the peak characteristics, and performing a cluster analysis on all the peaks according to the resolution factor; and performing dimensionality reduction processing on a category of peaks with the data dimensionality exceeding a dimensionality threshold.

### CROSS REFERENCE TO THE RELATED APPLICATIONS

This application is a continuation application of International Application No. PCT/CN2025/110774, filed on Jul. 26, 2025, which is based upon and claims priority to Chinese Patent Application No. 202411225118.4, filed on Sep. 3, 2024, the entire contents of which are incorporated herein by reference.

### TECHNICAL FIELD

The present disclosure relates to the technical field of data processing, and more particularly, relates to a method and system for mass spectrometer resolution enhancement based on data analysis.

### BACKGROUND

A mass spectrometer is an analytical instrument used to measure a mass and a quantity of ions in an ionized gas sample. The operating principle thereof is based on converting compounds in the sample into gaseous ions, which are then separated and detected according to a mass-to-charge ratio (m/z). The mass spectrometer is widely applied in various scientific fields, including chemistry, biochemistry, pharmaceutical development, environmental science, forensic science, and many others. Data generated by the mass spectrometer enable scientists to gain an in-depth understanding of a composition and properties of a substance, thereby advancing scientific research and application.

In the prior art, enhancing the resolution of the mass spectrometer is usually achieved by improving hardware and software. However, such improvement approach involves a high cost and a long cycle, resulting in poor adaptability and low efficiency in resolution enhancement. Relevant data generated by the mass spectrometer may directly or indirectly reflect the resolution, and the resolution of the mass spectrometer is enhanced through data analysis and processing means.

Therefore, the current technical problem to be solved is how to provide a method for enhancing the resolution of the mass spectrometer through data analysis.

### SUMMARY

An objective of the present disclosure is to provide a method for mass spectrometer resolution enhancement based on data analysis, so as to solve the technical problems in the prior art, such as the high resolution enhancement cost and poor enhancement efficiency.

To achieve the above objective, the present disclosure employs the following technical solutions:

A method for mass spectrometer resolution enhancement based on data analysis includes:
training a resolution factor model by using data from a mass analyzer, an ion optics system, ion transmission, an ion flight path, and a collision process, where the resolution factor describes a resolution potential of a mass spectrometer under different conditions;
determining basic information of a to-be-detected compound according to an original mass spectrum and an original fragment spectrum, identifying a most similar standard compound in a standard compound library according to the basic information of the to-be-detected compound, determining a target signal-to-noise ratio of the original mass spectrum according to a mass spectrum of the standard compound, and performing denoising processing on the original mass spectrum through a noise reduction means to achieve the target signal-to-noise ratio;
determining a baseline reference region according to the denoised original mass spectrum and the mass spectrum of the standard compound, and optimizing the baseline reference region through an Asymmetric Least Squares (ALS) algorithm to obtain a mass spectrum with baseline drift removed;
identifying characteristics of peaks in the mass spectrum, separating overlapped peaks through the peak characteristics to obtain all peaks, and performing a cluster analysis on all the peaks according to the resolution factor to categorize similar peaks; and
determining data dimensionality of each category of peaks, and performing dimensionality reduction processing on the category of peaks with the data dimensionality exceeding a dimensionality threshold to enhance the resolution of the mass spectrometer;
where the original fragment spectrum is a fragment spectrum of activated ions.

In some embodiments of the present disclosure, the training a resolution factor model by using data from a mass analyzer, an ion optics system, ion transmission, an ion flight path, and a collision process includes:
collecting data from a mass analyzer, an ion optics system, ion transmission, an ion flight path, and a collision process, and corresponding resolution data within a period of time, generating time series data corresponding to each part in a chronological order, and determining a degree of influence of the time series data of each part on the resolution data;
defining a hierarchical structure to sequentially include an ion source layer, an ion transmission layer, a mass analyzer layer, and a detector layer, and correspondingly inputting the time series data of the mass analyzer, the ion optics system, the ion transmission, the ion flight path, and the collision process according to the ion source layer, the ion transmission layer, the mass analyzer layer, and the detector layer;
determining a training ratio according to a ratio between the degrees of influence of the time series data of a plurality of parts on the resolution data, and segmenting the time series data of each part into a training set and a test set according to the training ratio to integrate the training set and the test set of the time series data of each part; and
training a multi-layer model having the hierarchical structure sequentially including the ion source layer, the ion transmission layer, the mass analyzer layer, and the detector layer by using the training sets, and adjusting and optimizing the multi-layer model according to the test sets.

In some embodiments of the present disclosure, the identifying a most similar standard compound in a standard compound library according to the basic information of the to-be-detected compound includes:
selecting a plurality of candidate standard compounds by comparing structural composition information of the to-be-detected compound with structural composition information of each standard compound in the standard compound library, where the basic information includes the structural composition information and peak characteristics;
performing normalization processing on differences in each type of structural composition information between the to-be-detected compound and the candidate standard compounds, integrating the differences in each type of structural composition information to obtain a comprehensive structural composition information difference index, and screening the plurality of candidate standard compounds according to the comprehensive structural composition information difference to select a first candidate standard compound and a second candidate standard compound;
sequentially comparing similarities in peak characteristics between the to-be-detected compound and the first candidate standard compound and between the to-be-detected compound and the second candidate standard compound to determine a basic information similarity index in combination with the comprehensive structural composition information difference index;

$${P}_{x , y} = \sqrt{{\sum }_{i = 1}^{n} ( {{α}_{i} ( {x}_{i} - {y}_{i} )}^{2} )} exp \{ \frac{Q}{k} \} ;$$

in the formula, P_{x,y} represents the basic information similarity index between the to-be-detected compound x and the first candidate standard compound or the second candidate standard compound y, n represents the number of peak characteristics, αᵢ represents a weight corresponding to the i^{th} peak characteristic, xᵢ represents a magnitude of the i^{th} peak characteristic of the to-be-detected compound, yᵢ represents a magnitude of the i^{th} peak characteristic of the first candidate standard compound or the second candidate standard compound,

$$\sqrt{{\sum }_{i = 1}^{n} ( {{α}_{i} ( {x}_{i} - {y}_{i} )}^{2} )}$$

represents a similarity of the peak characteristics, exp represents an exponential function, Q represents a comprehensive structural composition information difference index of the first candidate standard compound or the second candidate standard compound, and k represents a constant corresponding to the first candidate standard compound or the second candidate standard compound; and
selecting the first candidate standard compound or the second candidate standard compound with the smallest basic information similarity index as a standard compound that is the most similar to the to-be-detected compound.

In some embodiments of the present disclosure, the determining a target signal-to-noise ratio of the original mass spectrum according to a mass spectrum of the standard compound includes:
acquiring a mass spectrum of the standard compound, determining a plurality of types of representative peaks on the mass spectrum, calculating an area of each type of representative peak, determining a peak adjacency region according to the type of each representative peak, determining a signal-to-noise ratio of each type of representative peak through the peak area and the peak adjacency region, and integrating the signal-to-noise ratios of all the representative peaks to obtain a signal-to-noise ratio of the mass spectrum of the standard compound; and
mapping the basic information similarity index between the to-be-detected compound and the standard compound to obtain a target percentage, and determining a target signal-to-noise ratio of the original mass spectrum according to the target percentage and the signal-to-noise ratio of the mass spectrum of the standard compound.

In some embodiments of the present disclosure, the determining a baseline reference region according to the denoised original mass spectrum and the mass spectrum of the standard compound includes:
determining a minimum signal value within a peripheral region around a starting point on the denoised original mass spectrum, determining a maximum signal value on the denoised original mass spectrum, and determining an extension distance according to a ratio of the minimum signal value to the maximum signal value;
identifying a point corresponding to the minimum signal value within the peripheral region around the starting point as a baseline starting point, extending the baseline starting point according to the extension distance to determine a first baseline region, and determining a second baseline region in the mass spectrum of the standard compound; and
when an intersection exists between the first baseline region and the second baseline region, employing the intersection baseline region as a baseline reference region;
or otherwise, employing a region between the first baseline region and the second baseline region as the baseline reference region.

In some embodiments of the present disclosure, the separating overlapped peaks through the peak characteristics to obtain all peaks includes:
performing standardization processing on all the peak characteristics, and employing intuitive marginal discriminant analysis (IMDA) or independent component analysis (ICA) to identify and separate overlapped peaks to obtain all individual peaks.

In some embodiments of the present disclosure, the performing a cluster analysis on all the peaks according to the resolution factor to categorize similar peaks includes:
determining a plurality of types of representative peaks on the mass spectrum, calculating the area of each type of representative peak, and determining a minimum distance in a clustering algorithm in combination with the resolution factor;

$$L = ρ \{ \frac{1}{m} {\sum }_{j = 1}^{m} ( {β}_{j} {S}_{j} ) \to {L}_{0} \} ;$$

in the formula, L represents the minimum distance in the clustering algorithm, ρ represents the resolution factor, m represents the number of types of representative peaks, βⱼ represents an area ratio of the j^{th} type of peak, Sⱼ represents an area of the j^{th} type of peak, L₀ represents an initial minimum distance,

$$\frac{1}{m} {\sum }_{j = 1}^{m} ( {β}_{j} {S}_{j} ) \to {L}_{0}$$

represents an initial minimum distance obtained by mapping of an average area; and
performing a cluster analysis on all the peaks according to the minimum distance to categorize similar peaks.

In some embodiments of the present disclosure, the determining data dimensionality of each category of peaks, and performing dimensionality reduction processing on the category of peaks with the data dimensionality exceeding a dimensionality threshold includes:
evaluating the data dimensionality of each category of peaks, calculating the position and retention time of each category of peaks, setting a dimensionality threshold according to standard deviations of the position and the retention time, and performing dimensionality reduction processing on a category of peaks with the data dimensionality exceeding the dimensionality threshold.

Correspondingly, the present disclosure further provides a system for mass spectrometer resolution enhancement based on data analysis, including:
a training module configured to train a resolution factor model using data from a mass analyzer, an ion optics system, ion transmission, an ion flight path, and a collision process, where the resolution factor describes a resolution potential of a mass spectrometer under different conditions;
a determination module configured to determine basic information of a to-be-detected compound according to an original mass spectrum and an original fragment spectrum, identify a most similar standard compound in a standard compound library according to the basic information of the to-be-detected compound, determine a target signal-to-noise ratio of the original mass spectrum according to a mass spectrum of the standard compound, and perform denoising processing on the original mass spectrum through a noise reduction means to achieve the target signal-to-noise ratio;
a removal module configured to determine a baseline reference region according to the denoised original mass spectrum and the mass spectrum of the standard compound, and optimize the baseline reference region through an ALS algorithm to obtain a mass spectrum with baseline drift removed;
a categorization module configured to identify characteristics of peaks in the mass spectrum, separate overlapped peaks through the peak characteristics to obtain all peaks, and perform cluster analysis on all the peaks according to the resolution factor to categorize similar peaks; and
a dimensionality reduction module configured to determine data dimensionality of each category of peaks, and perform dimensionality reduction processing on the category of peaks with the data dimensionality exceeding a dimensionality threshold to enhance the resolution of the mass spectrometer;
where the original fragment spectrum is a fragment spectrum of activated ions.

By applying the above technical solutions, a resolution factor model is trained by using data from a mass analyzer, an ion optics system, ion transmission, an ion flight path, and a collision process, where the resolution factor describes a resolution potential of a mass spectrometer under different conditions; basic information of a to-be-detected compound is determined according to an original mass spectrum and an original fragment spectrum, a most similar standard compound is identified in a standard compound library according to the basic information of the to-be-detected compound, a target signal-to-noise ratio of the original mass spectrum is determined according to a mass spectrum of the standard compound, and denoising processing is performed on the original mass spectrum through a noise reduction means to achieve the target signal-to-noise ratio; a baseline reference region is determined according to the denoised original mass spectrum and the mass spectrum of the standard compound, and the baseline reference region is optimized through an ALS algorithm to obtain a mass spectrum with baseline drift removed; characteristics of peaks are identified in the mass spectrum, overlapped peaks are separated through the peak characteristics to obtain all peaks, and cluster analysis is performed on all the peaks according to the resolution factor to categorize similar peaks; and data dimensionality of each category of peaks is determined, and dimensionality reduction processing is performed on the category of peaks with the data dimensionality exceeding a dimensionality threshold to enhance the resolution of the mass spectrometer. In the present disclosure, the resolution factor model is trained to assist in subsequent cluster analysis of the peaks, and the target signal-to-noise ratio of the original mass spectrum is determined according to the mass spectrum of the standard compound. As a result, reasonable denoising of the mass spectrum is achieved, the problem of distortion due to excessive or insufficient noise is prevented, and the data quality of the mass spectrum is improved. The baseline reference region is determined according to the denoised original mass spectrum and the mass spectrum of the standard compound, and a baseline is optimized, such that data inconsistency caused by baseline drift is reduced or prevented. Finally, the resolution of a mass spectrometer is improved through separation of the overlapped peaks, clustering of the peaks, and dimensionality reduction processing of the peaks, and the resolution enhancement efficiency is ensured.

### BRIEF DESCRIPTION OF THE DRAWINGS

FIG. 1 is a schematic flow chart of a method for mass spectrometer resolution enhancement based on data analysis provided by the present disclosure.

FIG. 2 is a schematic structural diagram of a system for mass spectrometer resolution enhancement based on data analysis.

### DETAILED DESCRIPTION OF THE EMBODIMENTS

The technical solutions in embodiments of the present disclosure will be clearly and completely described below in combination with the drawings in embodiments of the present disclosure. It is obvious that the described embodiments are only a part of, rather than all of, the embodiments of the present disclosure. On the basis of the embodiments in the present disclosure, all other embodiments obtained by those of ordinary skill in the art without making creative efforts will fall within the protection scope of the present disclosure.

The present disclosure provides a method for mass spectrometer resolution enhancement based on data analysis, where an operating process and principle of a mass spectrometer may be summarized by the following steps:

### 1. Sample Introduction:

A sample is first converted into gaseous ions through various ionization techniques. Common ionization techniques include electron impact ionization (EI), electrospray ionization (ESI), and atmospheric pressure chemical ionization (APCI). Different techniques are suitable for different sample types and analytical objectives.

### 2. Ion Transmission:

The ionized sample enters an ion transmission system. This system typically includes components such as an ion mirror and a lens, and is configured to guide and focus the ions to ensure efficient transmission of the ions into a mass analyzer.

### 3. Mass Analysis:

The mass analyzer, as a core component of the mass spectrometer, is configured to separate the ions according to a mass-to-charge ratio (m/z). Common types of mass analyzers include a magnetic-sector mass analyzer, a quadrupole mass analyzer, a time-of-flight (TOF) mass analyzer, an ion trap mass analyzer, and a Fourier transform ion cyclotron resonance (FT-ICR) mass analyzer. The operating principles of these mass analyzers are different, but the objectives are to separate the ions according to the mass-to-charge ratio.

### 4. Ion Detection:

The separated ions are delivered to a detector, and the detector is configured to convert the ions into electrical signals. The detector may be an electron multiplier, a microchannel plate (MCP), and other types of photoelectric detectors.

### 5. Signal Recording and Processing:

Signals generated by the detector are recorded and processed by a data system. These data include a mass and a relative intensity of each ion, and finally a mass spectrum is generated.

### 6. Data Analysis:

The mass spectrum typically needs to be analyzed by specialized software to identify and quantify compounds in the sample. Data analysis may include steps such as peak detection, baseline correction, isotopic analysis, and fragment analysis.

### 7. Result Interpretation:

According to the information provided by the mass spectrum, a composition, a structure, a relative concentration, and the like of the sample are interpreted. This interpretation may involve comparison with databases, confirmation of known compounds, or structural inference of unknown compounds.

The mass spectrum is generated by the mass spectrometer and shows the mass-to-charge ratios (m/z) and relative intensities of different ions in the sample. In the mass spectrum, a horizontal axis represents the mass-to-charge ratio (m/z) of the ions, while a vertical axis represents an intensity or a quantity of the ions corresponding to each m/z value. A fragment spectrum and a mass spectrum are conceptually related, but are not completely identical. The fragment spectrum generally refers to an ion fragment spectrum detected by the mass spectrometer after collision-induced dissociation (CID) or other forms of activation. This type of spectrum shows the mass and relative intensity of fragment ions generated by fragmentation of precursor ions (parent ions) under the action of collision or electron impact. The mass spectrum represents a broader concept, includes any type of mass spectrometric data, and shows the mass and relative intensity of all ions in the sample, regardless of whether these ions are complete molecular ions, fragment ions, isotopic ions, or ions of other forms. The mass spectrum may be an ion spectrum detected directly without any activation, or may be a fragment ion spectrum obtained after an activation process (such as CID).

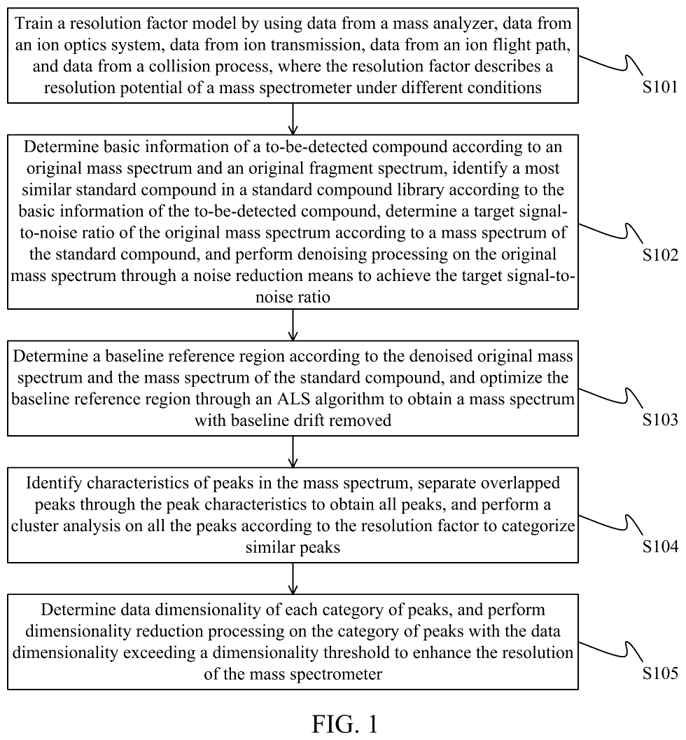

As shown in FIG. 1, the method includes the following steps:

S101, a resolution factor model is trained by using data from a mass analyzer, an ion optics system, ion transmission, an ion flight path, and a collision process, where the resolution factor describes a resolution potential of a mass spectrometer under different conditions.

In this embodiment, all parameters of these processes affect the resolution, and are therefore taken into consideration to train a resolution factor model. Operating parameters of the mass analyzer: In a magnetic-sector mass analyzer, adjusting a magnetic field intensity may influence a degree of ion deflection in a magnetic field to affect the resolution. In a quadrupole mass analyzer, adjusting a radio frequency may optimize ion focusing and separation in a quadrupole to affect the resolution. Ion optics system: The design and configuration of an ion mirror and a lens have an important impact on ion transmission and focusing. Parameters of these components affect the ion transmission efficiency and focusing performance to further alter the resolution. Ion source and transmission efficiency: The transmission efficiency of the ions in the mass spectrometer directly affects the resolution. By optimizing ion source parameters and a transmission system, the ion transmission efficiency is improved, thereby affecting the resolution. Ion flight path and collision process: A flight path of the ions in the mass analyzer directly affects the resolution. Parameters of the flight path, such as a distance between the ion source and the mass analyzer, as well as a length of the flight path, may affect the resolution. During a collision process, the ions may undergo mass deviation, thereby affecting the resolution.

In some embodiments of the present disclosure, the training a resolution factor model by using data from a mass analyzer, an ion optics system, ion transmission, an ion flight path, and a collision process includes:
Data from a mass analyzer, an ion optics system, ion transmission, an ion flight path, and a collision process, and corresponding resolution data within a period of time are collected, time series data corresponding to each part in a chronological order are generated, and a degree of influence of the time series data of each part on the resolution data is determined;
A hierarchical structure is defined to sequentially include an ion source layer, an ion transmission layer, a mass analyzer layer, and a detector layer, and the time series data of the mass analyzer, the ion optics system, the ion transmission, the ion flight path, and the collision process are correspondingly inputted according to the ion source layer, the ion transmission layer, the mass analyzer layer, and the detector layer;
A training ratio is determined according to a ratio between the degrees of influence of the time series data of a plurality of parts on the resolution data, and the time series data of each part are segmented into a training set and a test set according to the training ratio to integrate the training set and the test set of the time series data of each part; and
A multi-layer model having the hierarchical structure sequentially including the ion source layer, the ion transmission layer, the mass analyzer layer, and the detector layer is trained by using the training sets, and the multi-layer model is adjusted and optimized according to the test sets.

In this embodiment, the hierarchical structure is defined to sequentially include an ion source layer, an ion transmission layer, a mass analyzer layer, and a detector layer, as this sequence corresponds to an actual occurrence sequence, thereby fully simulating specific conditions. The hierarchical structure of the mass spectrometer is defined as follows:

The ion source layer includes parameters of the ion source, such as a temperature and a voltage.

The ion transmission layer includes parameters of the ion transmission system, such as voltages of the ion mirror and the lens.

The mass analyzer layer includes parameters of the mass analyzer, such as a voltage and a magnetic field intensity.

The detector layer includes parameters of the detector, such as a gain and a voltage.

Parameter adjustments at each layer are transmitted to a subsequent layer through a connection to affect the resolution of the subsequent layer.

In this embodiment, a degree of influence of time series data of each part on the resolution data is determined, and an influence quantity calculation method (such as Pearson correlation coefficient) is used to determine the degree of influence on resolution data. A training ratio is determined according to a ratio between the degrees of influence of the time series data of a plurality of parts on the resolution data, a relative degree of influence of the time-series data of each part is determined to establish the training ratio, and different relative degrees of influence correspond to different training ratios. The time series data of each part are segmented according to the training ratio. This training ratio refers to a temporal ratio, where the temporal data of an earlier portion serve as the training set, while the temporal data of a later portion serve as the test set.

It should be noted that the specific processes of model training, adjustment, and optimization are not key protection points of this solution. Any implementation that fulfills the above requirements should fall within the protection scope of the present disclosure.

S102, basic information of a to-be-detected compound is determined according to an original mass spectrum and an original fragment spectrum, a most similar standard compound is identified in a standard compound library according to the basic information of the to-be-detected compound, a target signal-to-noise ratio of the original mass spectrum is determined according to a mass spectrum of the standard compound, and denoising processing is performed on the original mass spectrum through a noise reduction means to achieve the target signal-to-noise ratio.

In this embodiment, basic information (including structural composition information and peak characteristics) of a to-be-detected compound is determined by comparing peaks in an original mass spectrum with peaks in an original fragment spectrum. A preliminary assessment is performed here to identify a most similar standard compound. This standard compound is then configured to set a target signal-to-noise ratio and a baseline region for preprocessing of the original mass spectrum.

In some embodiments of the present disclosure, the identifying a most similar standard compound in a standard compound library according to the basic information of the to-be-detected compound includes:
the basic information includes structural composition information and peak characteristics, a plurality of candidate standard compounds are selected by comparing the structural composition information of the to-be-detected compound with the structural composition information of each standard compound in the standard compound library;
normalization processing is performed on differences in each type of structural composition information between the to-be-detected compound and the candidate standard compounds, the differences in each type of structural composition information are integrated to obtain a comprehensive structural composition information difference index, and the plurality of candidate standard compounds are screened according to the comprehensive structural composition information difference to select a first candidate standard compound and a second candidate standard compound;
similarities in peak characteristics between the to-be-detected compound and the first candidate standard compound and between the to-be-detected compound and the second candidate standard compound are sequentially compared to determine a basic information similarity index in combination with the comprehensive structural composition information difference index;

$${P}_{x , y} = \sqrt{{\sum }_{i = 1}^{n} ( {{α}_{i} ( {x}_{i} - {y}_{i} )}^{2} )} exp \{ \frac{Q}{K} \} ;$$

in the formula, P_{x,y} represents the basic information similarity index between the to-be-detected compound x and the first candidate standard compound or the second candidate standard compound y, n represents the number of peak characteristics, αᵢ represents a weight corresponding to the i^{th} peak characteristic, xᵢ represents a magnitude of the i^{th} peak characteristic of the to-be-detected compound, yᵢ represents a magnitude of the i^{th} peak characteristic of the first candidate standard compound or the second candidate standard compound,

$$\sqrt{{\sum }_{i = 1}^{n} ( {{α}_{i} ( {x}_{i} - {y}_{i} )}^{2} )}$$

represents a similarity of the peak characteristics, exp represents an exponential function, Q represents a comprehensive structural composition information difference index of the first candidate standard compound or the second candidate standard compound, and k represents a constant corresponding to the first candidate standard compound or the second candidate standard compound; and
the first candidate standard compound or the second candidate standard compound with the smallest basic information similarity index is selected as a standard compound that is the most similar to the to-be-detected compound.

In this embodiment, the structural composition information includes a chemical structure, a molecular formula, a molecular weight, retention time, a concentration, and the like, and the peak characteristics include a width, an area, a shape, a position, an intensity ratio, and the like. A plurality of candidate standard compounds are selected by comparing the structural composition information of the to-be-detected compound with the structural composition information of each standard compound in a standard compound library. Here, analogous or similar candidate standard compounds are selected through a single type of structural composition information. Differences in each type of structural composition information are integrated to obtain a comprehensive structural composition information difference index (by weighted summation). A comprehensive structural composition information difference index of a first candidate standard compound is less than a comprehensive structural composition information difference index of a second candidate standard compound, and it indicates that the first candidate standard compound has a smaller overall difference and is more similar to the to-be-detected compound. Similarities in peak characteristics between the to-be-detected compound and the first candidate standard compound and between the to-be-detected compound and the second candidate standard compound are sequentially compared. Here, the similarity in peak characteristics is described by using a Euclidean distance, where a smaller value indicates a higher similarity. A value of

$$exp \{ \frac{Q}{K} \}$$

ranges from 1 to 1.34. The basic information similarity index is represented by combining two types of similarities in both the structural composition information and the peak characteristics.

In some embodiments of the present disclosure, the determining a target signal-to-noise ratio of the original mass spectrum according to a mass spectrum of the standard compound includes:
a mass spectrum of the standard compound is acquired, a plurality of types of representative peaks are determined on the mass spectrum, an area of each type of representative peak is calculated, a peak adjacency region is determined according to the type of each representative peak, a signal-to-noise ratio of each type of representative peak is determined through the peak area and the peak adjacency region, and the signal-to-noise ratios of all the representative peaks are integrated to obtain a signal-to-noise ratio of the mass spectrum of the standard compound; and
the basic information similarity index between the to-be-detected compound and the standard compound is mapped to obtain a target percentage, and a target signal-to-noise ratio of the original mass spectrum is determined according to the target percentage and the signal-to-noise ratio of the mass spectrum of the standard compound.

In this embodiment, a plurality of types of representative peaks are as follows: peaks with larger areas, as such peaks typically represent compounds with higher concentrations, and are particularly important for quantitative analysis; peaks with well-defined shapes, which generally indicate a high contrast between a signal and noise, i.e., a favorable signal-to-noise ratio; and peaks with retention time close to the retention time of the to-be-detected compound, which assists in determining the identity of the compound.

In this embodiment, a peak adjacency region is determined according to the type of each representative peak, and different types correspond to differently sized peak adjacency regions. The peak adjacency region refers to a peripheral distance around the peak. A signal-to-noise ratio of each type of representative peak is determined through the area and the peak adjacency region of the peak, and the signal-to-noise ratio is a ratio of the area of the peak to a noise level near the peak. Here, the signal-to-noise ratio of the peak is used to represent the signal-to-noise ratio of the mass spectrum, as the peak more accurately reflects composition information or other effective information. The target signal-to-noise ratio of the original mass spectrum is calculated as a product of a target percentage and the signal-to-noise ratio of the mass spectrum of the standard compound, and the target signal-to-noise ratio is set proportionally because the standard compound is different from the to-be-detected compound.

It should be noted that denoising processing is performed on the original mass spectrum through a noise reduction means. The specific means of denoising is not limited herein, provided that the target signal-to-noise ratio is achieved. Excessive noise may generate an analytical error, while insufficient noise may lead to signal loss.

S103, a baseline reference region is determined according to the denoised original mass spectrum and the mass spectrum of the standard compound, and the baseline reference region is optimized through an Asymmetric Least Squares (ALS) algorithm to obtain a mass spectrum with baseline drift removed.

In this embodiment, a baseline may vary automatically due to some factors, and these factors include changes in laboratory environments (such as temperature, humidity, and electromagnetic interference), instrument aging, and differences in sample preparation processes. These factors may lead to baseline drift, and influence the accuracy and repeatability of mass spectrometric data, thereby affecting the resolution. To eliminate the baseline drift, two common baseline correction algorithms are employed, including ALS and Adaptive Iterative Reweighted Least Squares (AirPLS). These algorithms are configured to iteratively calculate a baseline value at each time point and subtract the baseline value from an original signal to remove the baseline drift. Therefore, it is necessary to select a baseline reference region to facilitate subsequent baseline optimization.

In some embodiments of the present disclosure, the determining a baseline reference region according to the denoised original mass spectrum and the mass spectrum of the standard compound includes:
a minimum signal value is determined within a peripheral region around a starting point on the denoised original mass spectrum, a maximum signal value is determined on the denoised original mass spectrum, and an extension distance is determined by a ratio of the minimum signal value to the maximum signal value;
a point corresponding to the minimum signal value within the peripheral region around the starting point is identified as a baseline starting point, the baseline starting point is extended according to the extension distance to determine a first baseline region, and a second baseline region is determined in the mass spectrum of the standard compound; and
when an intersection exists between the first baseline region and the second baseline region, the intersection baseline region is employed as a baseline reference region;
or otherwise, a region between the first baseline region and the second baseline region is employed as the baseline reference region.

In this embodiment, determination of the baseline on the denoised original mass spectrum is typically based on an ordinate, i.e., a y-axis of the mass spectrum. The baseline represents a signal level when no ions pass through the detector, and a low value is generally set to facilitate display of an ion signal intensity. A low point portion of the ion signal is selected as a starting point of the baseline because significant ion signal peaks are absent in this region, such that the low point portion is suitable for serving as the starting point of the baseline. When the mass spectrometer begins to acquire data, there may be some warm-up or preparation stages, thereby resulting in a non-zero signal intensity at the starting point. Therefore, a relative minimum signal value is identified within a peripheral region. The extension distance is a distance of the y-axis. Different ratios of the minimum signal value to the maximum signal value correspond to different extension distances, thereby ensuring that the baseline region is relatively complete. When no intersection exists between the first baseline region and the second baseline region, a region between the first baseline region and the second baseline region is used as a baseline reference region. Generally, the two baseline regions remain close to each other even if such regions do not intersect.

S104, characteristics of peaks in the mass spectrum are identified, overlapped peaks are separated through the peak characteristics to obtain all peaks, and cluster analysis is performed on all the peaks according to the resolution factor to categorize similar peaks.

In some embodiments of the present disclosure, the separating overlapped peaks through the peak characteristics to obtain all peaks includes:

Standardization processing is performed on all the peak characteristics, and intuitive marginal discriminant analysis (IMDA) or independent component analysis (ICA) is employed to identify and separate overlapped peaks to obtain all individual peaks.

In this embodiment, IMDA is employed to calculate the similarity or distance between the peaks according to the peak characteristics. The resulting similarity or distance matrix assists in distinguishing different peaks, and overlapped peaks are identified and separated according to the results of the IMDA. ICA is employed, and the ICA is a signal processing technique capable of separating signals that have been mixed from a plurality of sources.

In some embodiments of the present disclosure, the performing a cluster analysis on all the peaks according to the resolution factor to categorize similar peaks includes:
a plurality of types of representative peaks is determined on the mass spectrum, the area of each type of representative peak is calculated, and a minimum distance in a clustering algorithm is determined in combination with the resolution factor;

$$L = ρ \{ \frac{1}{m} {\sum }_{j = 1}^{m} ( {β}_{j} {S}_{j} ) \to {L}_{0} \} ;$$

in the formula, L represents the minimum distance in the clustering algorithm, ρ represents the resolution factor, m represents the number of types of representative peaks, βⱼ represents an area ratio of the j^{th} type of peak, Sⱼ represents an area of the j^{th} type of peak, L₀ represents an initial minimum distance,

$$\frac{1}{m} {\sum }_{j = 1}^{m} ( {β}_{j} {S}_{j} ) \to {L}_{0}$$

represents an initial minimum distance obtained by mapping of an average area; and
a cluster analysis is performed on all the peaks according to the minimum distance to categorize similar peaks.

In this embodiment, a percentage of the peak area (an area ratio) is configured to assist in determination of a minimum distance to a certain extent. The resolution factor is configured to assisting in determination of the minimum distance in a clustering algorithm. The minimum distance refers to a minimum number of points which one core point must contain in a Density-Based Spatial Clustering of Applications with Noise (DBSCAN) algorithm. The resolution factor is configured to direct selection of the minimum distance, as a high resolution generally necessitates finer clustering. When the resolution factor indicates a high resolution, a smaller minimum distance is selected to enhance the granularity of clustering. Through cluster analysis, mass spectrum peaks with similar characteristics are distinguished, and these peaks may originate from the same type of compound or a homologous series of compounds. Once these peaks are identified and separated, each type of peak is analyzed individually to improve the resolution.

S105, data dimensionality of each category of peaks is determined, and dimensionality reduction processing is performed on the category of peaks with the data dimensionality exceeding a dimensionality threshold to enhance the resolution of the mass spectrometer; where the original fragment spectrum is a fragment spectrum of activated ions.

In some embodiments of the present disclosure, the determining data dimensionality of each category of peaks, and performing dimensionality reduction processing on the category of peaks with the data dimensionality exceeding a dimensionality threshold includes:

The data dimensionality of each category of peaks is evaluated, the position and retention time of each category of peaks are calculated, a dimensionality threshold is set according to standard deviations of the position and the retention time, and dimensionality reduction processing is performed on a category of peaks with the data dimensionality exceeding the dimensionality threshold.

In this embodiment, the peak position corresponds to the mass-to-charge ratio of the mass spectrum, and the retention time refers to a duration required for the compound to pass through a chromatographic column in a gas chromatograph. A dimensionality threshold is set according to standard deviations of the two parameters, and the peak position and the retention time reflect a separation state of the compound. A dimensionality reduction technique is configured to reduce data dimensionality and eliminate redundant information from the data. The mass spectrum is presented more clearly by reducing data dimensionality, thereby enhancing the resolution.

It should be noted that the specific processes of cluster analysis and dimensionality reduction are not key protection points of this solution, and any alternative solutions capable of fulfilling the above requirements are applicable. All correspondence or mapping relationships involved throughout the specification of the present disclosure may be derived from historical experience or mathematical relationships, and fall within the protection scope of the present disclosure.

By applying the above technical solutions, a resolution factor model is trained by using data from a mass analyzer, an ion optics system, ion transmission, an ion flight path, and a collision process, where the resolution factor describes a resolution potential of a mass spectrometer under different conditions; basic information of a to-be-detected compound is determined according to an original mass spectrum and an original fragment spectrum, a most similar standard compound is identified in a standard compound library according to the basic information of the to-be-detected compound, a target signal-to-noise ratio of the original mass spectrum is determined according to a mass spectrum of the standard compound, and denoising processing is performed on the original mass spectrum through a noise reduction means to achieve the target signal-to-noise ratio; a baseline reference region is determined according to the denoised original mass spectrum and the mass spectrum of the standard compound, and the baseline reference region is optimized through an ALS algorithm to obtain a mass spectrum with baseline drift removed; characteristics of peaks are identified in the mass spectrum, overlapped peaks are separated through the peak characteristics to obtain all peaks, and cluster analysis is performed on all the peaks according to the resolution factor to categorize similar peaks; and data dimensionality of each category of peaks is determined, and dimensionality reduction processing is performed on the category of peaks with the data dimensionality exceeding a dimensionality threshold to enhance the resolution of the mass spectrometer; In the present disclosure, the resolution factor model is trained to assist in subsequent cluster analysis of the peaks, and the target signal-to-noise ratio of the original mass spectrum is determined according to the mass spectrum of the standard compound. As a result, reasonable denoising of the mass spectrum is achieved, the problem of distortion due to excessive or insufficient noise is prevented, and the data quality of the mass spectrum is improved. The baseline reference region is determined according to the denoised original mass spectrum and the mass spectrum of the standard compound, and a baseline is optimized, such that data inconsistency caused by baseline drift is reduced or prevented. Finally, the resolution of a mass spectrometer is improved through separation of the overlapped peaks, clustering of the peaks, and dimensionality reduction processing of the peaks, and the resolution enhancement efficiency is ensured.

Through the description of the above embodiments, those skilled in the art may clearly understand that the present disclosure may be implemented by means of hardware, or by means of software in combination with a necessary general-purpose hardware platform. Based on such understanding, the technical solutions of the present disclosure may be embodied as a software product. This software product is stored in a non-volatile storage medium (which may be a CD-ROM, a USB flash disk, a mobile hard disk drive, and the like), and includes some instructions for enabling one computer device (which may be a personal computer, a server, a network device, and the like) to execute the method described in various implementation scenarios of the present disclosure.

To further elaborate on the technical concept of the present disclosure, the technical solutions of the present disclosure will be described in conjunction with specific application scenarios.

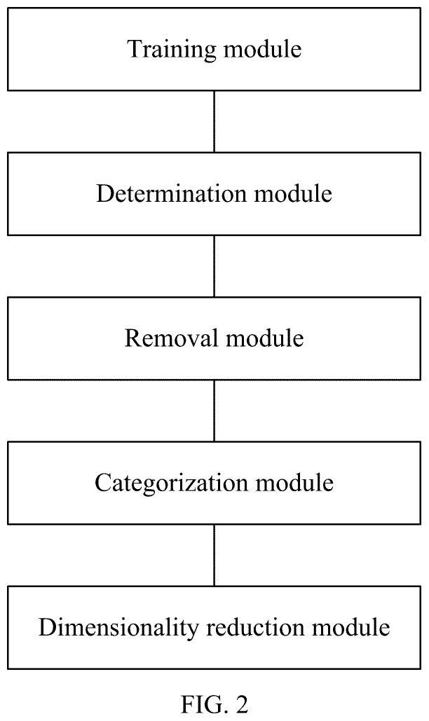

Correspondingly, the present disclosure further provides a system for mass spectrometer resolution enhancement based on data analysis, as shown in FIG. 2, including:
a training module configured to train a resolution factor model by using data from a mass analyzer, an ion optics system, ion transmission, an ion flight path, and a collision process, where the resolution factor describes a resolution potential of a mass spectrometer under different conditions;
a determination module configured to determine basic information of a to-be-detected compound according to an original mass spectrum and an original fragment spectrum, identify a most similar standard compound in a standard compound library according to the basic information of the to-be-detected compound, determine a target signal-to-noise ratio of the original mass spectrum according to a mass spectrum of the standard compound, and perform denoising processing on the original mass spectrum through a noise reduction means to achieve the target signal-to-noise ratio;
a removal module configured to determine a baseline reference region according to the denoised original mass spectrum and the mass spectrum of the standard compound, and optimize the baseline reference region through an ALS algorithm to obtain a mass spectrum with baseline drift removed;
a categorization module configured to identify characteristics of peaks in the mass spectrum, separate overlapped peaks through the peak characteristics to obtain all peaks, and perform cluster analysis on all the peaks according to the resolution factor to categorize similar peaks; and
a dimensionality reduction module configured to determine data dimensionality of each category of peaks, and perform dimensionality reduction processing on the category of peaks with the data dimensionality exceeding a dimensionality threshold to enhance the resolution of the mass spectrometer;
where the original fragment spectrum is a fragment spectrum of activated ions.

Those skilled in the art may understand that the modules in the system for an implementation scenario may be distributed in the system for the implementation scenario in accordance with the description of the implementation scenario, or alternatively, be correspondingly changed and located in one or more systems different from the system for this implementation scenario. The modules for the above implementation scenario may be combined into a single module or further split into a plurality of sub-modules.

Finally, it should be stated that the above embodiments are only used for explaining, rather than limiting, the technical solutions of the present disclosure. Although the present disclosure is described in detail with reference to the above embodiments, those of ordinary skill in the art should understand that modifications may be made to the technical solutions of the present disclosure, or equivalent substitutions may be made to part of the technical features thereof; and such modifications or equivalent substitutions will not cause the essences of the corresponding technical solutions to deviate from the spirit and scope of the technical solutions of various embodiments of the present disclosure.

What is claimed is:

1. A method for mass spectrometer resolution enhancement based on data analysis, comprising:
training a resolution factor model by using data from a mass analyzer, data from an ion optics system, data from ion transmission, data from an ion flight path, and data from a collision process, wherein a resolution factor describes a resolution potential of a mass spectrometer under different conditions;
determining basic information of a to-be-detected compound according to an original mass spectrum and an original fragment spectrum, identifying a most similar standard compound in a standard compound library according to the basic information of the to-be-detected compound, determining a target signal-to-noise ratio of the original mass spectrum according to a mass spectrum of the most similar standard compound, and performing denoising processing on the original mass spectrum through a noise reduction means to achieve the target signal-to-noise ratio;
determining a baseline reference region according to a denoised original mass spectrum and the mass spectrum of the most similar standard compound, and optimizing the baseline reference region through an Asymmetric Least Squares (ALS) algorithm to obtain a mass spectrum with baseline drift removed;
identifying peak characteristics in the mass spectrum with baseline drift removed, separating overlapped peaks through the peak characteristics to obtain all peaks, and performing a cluster analysis on all the peaks according to the resolution factor to categorize similar peaks; and
determining data dimensionality of each category of peaks, and performing dimensionality reduction processing on the category of peaks with the data dimensionality exceeding a dimensionality threshold to enhance a resolution of the mass spectrometer;
wherein a training process of the resolution factor model is as follows:
collecting the data from the mass analyzer, the data from the ion optics system, the data from the ion transmission, the data from the ion flight path, and the data from the collision process, and corresponding resolution data within a period of time, generating time series data corresponding to each part in a chronological order, and determining a degree of influence of the time series data of each part on the corresponding resolution data;
defining a hierarchical structure to sequentially comprise an ion source layer, an ion transmission layer, a mass analyzer layer, and a detector layer, and correspondingly inputting the time series data of the mass analyzer, the ion optics system, the ion transmission, the ion flight path, and the collision process according to the ion source layer, the ion transmission layer, the mass analyzer layer, and the detector layer;
determining a training ratio according to a ratio between degrees of influence of the time series data of a plurality of parts on the corresponding resolution data, and segmenting the time series data of each part into a training set and a test set according to the training ratio to integrate the training set and the test set of the time series data of each part; and
training a multi-layer model having the hierarchical structure sequentially comprising the ion source layer, the ion transmission layer, the mass analyzer layer, and the detector layer by using training sets, and adjusting and optimizing the multi-layer model according to test sets;
wherein the original fragment spectrum is a fragment spectrum of activated ions, the data from the mass analyzer are operating parameters of the mass analyzer, the data from the ion optics system are design parameters of an ion mirror and a lens, the data from the ion transmission are ion transmission efficiency, the data from the ion flight path are ion flight path parameters, and the data from the collision process are parameters generated in an ion collision process.

2. The method for the mass spectrometer resolution enhancement based on the data analysis according to claim 1, wherein the identifying the most similar standard compound in the standard compound library according to the basic information of the to-be-detected compound comprises:
selecting a plurality of candidate standard compounds by comparing structural composition information of the to-be-detected compound with structural composition information of each standard compound in the standard compound library, wherein the basic information comprises the structural composition information and the peak characteristics;
performing normalization processing on differences in each type of structural composition information between the to-be-detected compound and the plurality of candidate standard compounds, integrating the differences in each type of structural composition information to obtain a comprehensive structural composition information difference index, and screening the plurality of candidate standard compounds according to the comprehensive structural composition information difference to select a first candidate standard compound and a second candidate standard compound;
sequentially comparing similarities in peak characteristics between the to-be-detected compound and the first candidate standard compound and between the to-be-detected compound and the second candidate standard compound to determine a basic information similarity index in combination with the comprehensive structural composition information difference index;
$${P}_{x , y} = \sqrt{{\sum }_{i = 1}^{n} ( {{α}_{i} ( {x}_{i} - {y}_{i} )}^{2} )} exp \{ \frac{Q}{K} \} ;$$
in a formula, P_{x,y} represents the basic information similarity index between the to-be-detected compound x and the first candidate standard compound or the second candidate standard compound y, n represents a number of the peak characteristics, αᵢ represents a weight corresponding to an i^{th} peak characteristic, xⁱ represents a magnitude of the i^{th} peak characteristic of the to-be-detected compound, yᵢ represents a magnitude of the i^{th} peak characteristic of the first candidate standard compound or the second candidate standard compound,
$$\sqrt{{\sum }_{i = 1}^{n} ( {{α}_{i} ( {x}_{i} - {y}_{i} )}^{2} )}$$
represents a similarity of the peak characteristics, exp represents an exponential function, Q represents a comprehensive structural composition information difference index of the first candidate standard compound or the second candidate standard compound, and k represents a constant corresponding to the first candidate standard compound or the second candidate standard compound; and
selecting the first candidate standard compound or the second candidate standard compound with a smallest basic information similarity index as the most similar standard compound of the to-be-detected compound.

3. The method for the mass spectrometer resolution enhancement based on the data analysis according to claim 2, wherein the determining the target signal-to-noise ratio of the original mass spectrum according to the mass spectrum of the most similar standard compound comprises:
acquiring the mass spectrum of the most similar standard compound, determining a plurality of types of representative peaks on the mass spectrum, calculating a peak area of each type of representative peak, determining a peak adjacency region according to a type of each representative peak, determining a signal-to-noise ratio of each type of representative peak through the peak area and the peak adjacency region, and integrating signal-to-noise ratios of all the plurality of types of representative peaks to obtain a signal-to-noise ratio of the mass spectrum of the most similar standard compound; and
mapping a basic information similarity index between the to-be-detected compound and the most similar standard compound to obtain a target percentage, and determining the target signal-to-noise ratio of the original mass spectrum according to the target percentage and the signal-to-noise ratio of the mass spectrum of the most similar standard compound.

4. The method for the mass spectrometer resolution enhancement based on the data analysis according to claim 1, wherein the determining the baseline reference region according to the denoised original mass spectrum and the mass spectrum of the most similar standard compound comprises:
determining a minimum signal value within a peripheral region around a starting point on the denoised original mass spectrum, determining a maximum signal value on the denoised original mass spectrum, and determining an extension distance according to a ratio of the minimum signal value to the maximum signal value;
identifying a point corresponding to the minimum signal value within the peripheral region around the starting point as a baseline starting point, extending the baseline starting point according to the extension distance to determine a first baseline region, and determining a second baseline region in the mass spectrum of the most similar standard compound; and
when an intersection exists between the first baseline region and the second baseline region, employing an intersection baseline region as the baseline reference region;
when no intersection exists between the first baseline region and the second baseline region, employing a region between the first baseline region and the second baseline region as the baseline reference region.

5. The method for the mass spectrometer resolution enhancement based on the data analysis according to claim 1, wherein the separating the overlapped peaks through the peak characteristics to obtain all the peaks comprises:
performing standardization processing on all the peak characteristics, and employing an intuitive marginal discriminant analysis (IMDA) or an independent component analysis (ICA) to identify and separate the overlapped peaks to obtain all individual peaks.

6. The method for the mass spectrometer resolution enhancement based on the data analysis according to claim 1, wherein the performing the cluster analysis on all the peaks according to the resolution factor to categorize the similar peaks comprises:
determining a plurality of types of representative peaks on the mass spectrum, calculating an area of each type of representative peak, and determining a minimum distance in a clustering algorithm in combination with the resolution factor;
$$L = ρ \{ \frac{1}{m} {\sum }_{j = 1}^{m} ( {β}_{j} {S}_{j} ) \to {L}_{0} \} ;$$
in a formula, L represents the minimum distance in the clustering algorithm, ρ represents the resolution factor, m represents a number of types of representative peaks, βⱼ represents an area ratio of a j^{th} type of peak, Sⱼ represents an area of the j^{th} type of peak, L₀ represents an initial minimum distance,
$$\frac{1}{m} {\sum }_{j = 1}^{m} ( {β}_{j} {S}_{j} ) \to {L}_{0}$$
represents an initial minimum distance obtained by mapping of an average area; and
performing the cluster analysis on all the peaks according to the minimum distance to categorize the similar peaks.

7. The method for the mass spectrometer resolution enhancement based on the data analysis according to claim 1, wherein the determining the data dimensionality of each category of peaks, and performing the dimensionality reduction processing on the category of peaks with the data dimensionality exceeding the dimensionality threshold comprises:
evaluating the data dimensionality of each category of peaks, calculating a position and a retention time of each category of peaks, setting the dimensionality threshold according to standard deviations of the position and the retention time, and performing the dimensionality reduction processing on the category of peaks with the data dimensionality exceeding the dimensionality threshold.

8. A system for mass spectrometer resolution enhancement based on data analysis, configured to implement the method for the mass spectrometer resolution enhancement based on the data analysis according to claim 1, wherein the system comprises:
a training module configured to train the resolution factor model by using the data from the mass analyzer, the data from the ion optics system, the data from the ion transmission, the data from the ion flight path, and the data from the collision process, wherein the resolution factor describes the resolution potential of the mass spectrometer under the different conditions;
a determination module configured to determine the basic information of the to-be-detected compound according to the original mass spectrum and the original fragment spectrum, identify the most similar standard compound in the standard compound library according to the basic information of the to-be-detected compound, determine the target signal-to-noise ratio of the original mass spectrum according to the mass spectrum of the most similar standard compound, and perform the denoising processing on the original mass spectrum through the noise reduction means to achieve the target signal-to-noise ratio;
a removal module configured to determine the baseline reference region according to the denoised original mass spectrum and the mass spectrum of the most similar standard compound, and optimize the baseline reference region through the ALS algorithm to obtain the mass spectrum with baseline drift removed;
a categorization module configured to identify the peak characteristics in the mass spectrum with baseline drift removed, separate the overlapped peaks through the peak characteristics to obtain all the peaks, and perform the cluster analysis on all the peaks according to the resolution factor to categorize the similar peaks; and
a dimensionality reduction module configured to determine the data dimensionality of each category of peaks, and perform the dimensionality reduction processing on the category of peaks with the data dimensionality exceeding the dimensionality threshold to enhance the resolution of the mass spectrometer;
wherein the original fragment spectrum is the fragment spectrum of the activated ions, the data from the mass analyzer are the operating parameters of the mass analyzer, the data from the ion optics system are the design parameters of the ion mirror and the lens, the data from the ion transmission are the ion transmission efficiency, the data from the ion flight path are the ion flight path parameters, and the data from the collision process are the parameters generated in the ion collision process.

9. The system for the mass spectrometer resolution enhancement based on the data analysis according to claim 8, wherein in the method for mass spectrometer resolution enhancement based on data analysis, the identifying the most similar standard compound in the standard compound library according to the basic information of the to-be-detected compound comprises:
selecting a plurality of candidate standard compounds by comparing structural composition information of the to-be-detected compound with structural composition information of each standard compound in the standard compound library, wherein the basic information comprises the structural composition information and the peak characteristics;
performing normalization processing on differences in each type of structural composition information between the to-be-detected compound and the plurality of candidate standard compounds, integrating the differences in each type of structural composition information to obtain a comprehensive structural composition information difference index, and screening the plurality of candidate standard compounds according to the comprehensive structural composition information difference to select a first candidate standard compound and a second candidate standard compound;
sequentially comparing similarities in peak characteristics between the to-be-detected compound and the first candidate standard compound and between the to-be-detected compound and the second candidate standard compound to determine a basic information similarity index in combination with the comprehensive structural composition information difference index;
$${P}_{x , y} = \sqrt{{\sum }_{i = 1}^{n} ( {{α}_{i} ( {x}_{i} - {y}_{i} )}^{2} )} exp \{ \frac{Q}{K} \} ;$$
in a formula, P_{x,y} represents the basic information similarity index between the to-be-detected compound x and the first candidate standard compound or the second candidate standard compound y, n represents a number of the peak characteristics, αᵢ represents a weight corresponding to an i^{th} peak characteristic, xᵢ represents a magnitude of the i^{th} peak characteristic of the to-be-detected compound, yᵢ represents a magnitude of the i^{th} peak characteristic of the first candidate standard compound or the second candidate standard compound,
$$\sqrt{{\sum }_{i = 1}^{n} ( {{α}_{i} ( {x}_{i} - {y}_{i} )}^{2} )}$$
represents a similarity of the peak characteristics, exp represents an exponential function, Q represents a comprehensive structural composition information difference index of the first candidate standard compound or the second candidate standard compound, and k represents a constant corresponding to the first candidate standard compound or the second candidate standard compound; and
selecting the first candidate standard compound or the second candidate standard compound with a smallest basic information similarity index as the most similar standard compound of the to-be-detected compound.

10. The system for the mass spectrometer resolution enhancement based on the data analysis according to claim 9, wherein in the method for mass spectrometer resolution enhancement based on data analysis, the determining the target signal-to-noise ratio of the original mass spectrum according to the mass spectrum of the most similar standard compound comprises:
acquiring the mass spectrum of the most similar standard compound, determining a plurality of types of representative peaks on the mass spectrum, calculating a peak area of each type of representative peak, determining a peak adjacency region according to a type of each representative peak, determining a signal-to-noise ratio of each type of representative peak through the peak area and the peak adjacency region, and integrating signal-to-noise ratios of all the plurality of types of representative peaks to obtain a signal-to-noise ratio of the mass spectrum of the most similar standard compound; and
mapping a basic information similarity index between the to-be-detected compound and the most similar standard compound to obtain a target percentage, and determining the target signal-to-noise ratio of the original mass spectrum according to the target percentage and the signal-to-noise ratio of the mass spectrum of the most similar standard compound.

11. The system for the mass spectrometer resolution enhancement based on the data analysis according to claim 8, wherein in the method for mass spectrometer resolution enhancement based on data analysis, the determining the baseline reference region according to the denoised original mass spectrum and the mass spectrum of the most similar standard compound comprises:
determining a minimum signal value within a peripheral region around a starting point on the denoised original mass spectrum, determining a maximum signal value on the denoised original mass spectrum, and determining an extension distance according to a ratio of the minimum signal value to the maximum signal value;
identifying a point corresponding to the minimum signal value within the peripheral region around the starting point as a baseline starting point, extending the baseline starting point according to the extension distance to determine a first baseline region, and determining a second baseline region in the mass spectrum of the most similar standard compound; and
when an intersection exists between the first baseline region and the second baseline region, employing an intersection baseline region as the baseline reference region;
when no intersection exists between the first baseline region and the second baseline region, employing a region between the first baseline region and the second baseline region as the baseline reference region.

12. The system for the mass spectrometer resolution enhancement based on the data analysis according to claim 8, wherein in the method for mass spectrometer resolution enhancement based on data analysis, the separating the overlapped peaks through the peak characteristics to obtain all the peaks comprises:
performing standardization processing on all the peak characteristics, and employing an IMDA or an ICA to identify and separate the overlapped peaks to obtain all individual peaks.

13. The system for the mass spectrometer resolution enhancement based on the data analysis according to claim 8, wherein in the method for mass spectrometer resolution enhancement based on data analysis, the performing the cluster analysis on all the peaks according to the resolution factor to categorize the similar peaks comprises:
determining a plurality of types of representative peaks on the mass spectrum, calculating an area of each type of representative peak, and determining a minimum distance in a clustering algorithm in combination with the resolution factor;
$$L = ρ \{ \frac{1}{m} {\sum }_{j = 1}^{m} ( {β}_{j} {S}_{j} ) \to {L}_{0} \} ;$$
in a formula, L represents the minimum distance in the clustering algorithm, ρ represents the resolution factor, m represents a number of types of representative peaks, βⱼ represents an area ratio of a j^{th} type of peak, Sⱼ represents an area of the j^{th} type of peak, L₀ represents an initial minimum distance,
$$\frac{1}{m} {\sum }_{j = 1}^{m} ( {β}_{j} {S}_{j} ) \to {L}_{0}$$
represents an initial minimum distance obtained by mapping of an average area; and
performing the cluster analysis on all the peaks according to the minimum distance to categorize the similar peaks.

14. The system for the mass spectrometer resolution enhancement based on the data analysis according to claim 8, wherein in the method for mass spectrometer resolution enhancement based on data analysis, the determining the data dimensionality of each category of peaks, and performing the dimensionality reduction processing on the category of peaks with the data dimensionality exceeding the dimensionality threshold comprises:
evaluating the data dimensionality of each category of peaks, calculating a position and a retention time of each category of peaks, setting the dimensionality threshold according to standard deviations of the position and the retention time, and performing the dimensionality reduction processing on the category of peaks with the data dimensionality exceeding the dimensionality threshold.
